(19) United States
(12) Patent Application Publication
(10) Pub. No.: US 2003/0234627 A1
(43) Pub. Date: Dec. 25, 2003

(54) Motor with dynamic current draw

(76) Inventors: Mark Reinhold, Langhorne, PA (US); Frank Cettina, Robbinsville, NJ (US); Kenneth Hoffmann, McKinney, TX (US); Steve Miller, Allentown, NJ (US)

Correspondence Address: Steven G. Saunders, Bromberg & Sunstein LLP, 125 Summer Street, Boston, MA, 02110-1618, US

(21) Appl. No.: 10/443,295

(22) Filed: May 22, 2003

Related U.S. Application Data
(60) Provisional application No. 60/390,261, filed on Jun. 20, 2002.

(51) Int. Cl. H02K 27/30

(52) U.S. Cl. 318/434

(57) ABSTRACT

To improve performance, a motor varies its current draw based upon its input voltage. To that end, the motor has an input for receiving an input voltage, and a current controller operatively coupled with the input. The current controller is capable of detecting the current drawn by the motor. In addition, the current controller is capable of changing the current draw as a function of the input voltage.

### PRIORITY

This patent application claims priority from provisional U.S. patent application No. 60/390,261, filed Jun. 20, 2002, entitled, “MOTOR WITH DYNAMIC CURRENT DRAW,” and naming Mark Reinhold, Kenneth Hoffmann, Frank Cettina, and Steve Miller as inventors, the disclosure of which is incorporated herein, in its entirety, by reference.

### FIELD OF THE INVENTION

This invention relates generally to electric motors and, more particularly, this invention relates to devices and methods of controlling current draw in electric motors.

### BACKGROUND OF THE INVENTION

In simplified terms, electric motors (e.g., DC electric motors) have a rotating portion (“rotor”) rotatably secured to a stationary portion (“stator”) that controls rotor rotation. More specifically, the rotor in various types of DC electric motors has a magnet that interacts with a fluctuating magnetic field produced by the stator. This interaction causes the rotor to rotate at a speed controlled by the stator. To produce the fluctuating magnetic field, the stator typically includes a metallic stator core, which is made up of a plurality of stacked metal laminations, a coil wrapped around the stator core, and circuitry for selectively energizing the coil. The circuitry detects the magnetic field produced by the magnet within the rotor and thus, selectively energizes the coil to provide the rotating energy.

Heat produced by motors operating at relatively high power levels undesirably can cause motor failure (e.g., the circuitry can overheat or the coils can fail). Consequently, electric motors typically are rated to operate at a specified power level (e.g., plus or minus ten percent). To ensure that they do not significantly exceed their rated power levels, motors typically have a current limiting circuit that permits no more than a pre-set current to be drawn. This current commonly is set to a value that, when drawn with expected input voltages, should not exceed the rated power level of the motor.

Motor speed and torque of a motor, however, both are a function of its current and thus, are limited by the pre-set current value. Undesirably, this pre-set current often is not high enough to permit the motor to operate at the rated power. Consequently, such a motor generally operates at a speed that is less than the speed it would operate if it received its rated power.

### SUMMARY OF THE INVENTION

In accordance with one aspect of the invention, to improve performance, a motor varies its current draw based upon its input voltage. To that end, the motor has an input for receiving an input voltage, and a current controller operatively coupled with the input. The current controller is capable of detecting the current drawn by the motor. In addition, the current controller is capable of changing the current draw as a function of the input voltage.

The motor may have a rated power value, where the current controller is capable of controlling the current draw as a function of the rated power. In some embodiments, the current controller is capable of changing the current draw in an inversely proportional manner to the input voltage. Among other things, the current controller may include a pulse width modulator to control current draw.

In some embodiments, the current controller includes a programmable element capable of executing program code. The motor also may have a stator and a rotor that is rotatably attached to the stator. The rotor speed is controlled by the current controller. The motor also may have a coil. The current draw thus may be a function of at least one characteristic of the coil. The motor also may have voltage sensor that is 1) capable of measuring the input voltage and 2) in electrical communication with the current controller.

In accordance with another aspect of the invention, an apparatus and method for controlling motor speed receives an input voltage that powers the motor, and calculates the power produced by the input voltage. The power produced by the input voltage then is compared to a given power, and the current drawn by the motor is controlled as a function of this comparison. The power produced by the input voltage is a function of the current drawn by the motor.

The current drawn may be increased if the power produced is less than the given power. Conversely, the current drawn may be decreased if the power produced is greater than the given power. The current draw may be controlled by pulse width modulating the input voltage. In some embodiments, the given voltage is preprogrammed into a programmable element that controls the current drawn. The programmable element illustratively is capable of executing program code. In some embodiments, the value of the input voltage may be calculated.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

The foregoing and advantages of the invention will be appreciated more fully from the following further description thereof with reference to the accompanying drawings wherein:

FIG. 1 schematically shows an exemplary motor that may be implemented to incorporate illustrative embodiments of the invention.

FIG. 2 schematically shows a circuit diagram of a stator circuit that may be used in the motor shown in FIG. 1.

FIG. 3 shows a process of dynamically modifying current drawn by the coil shown in the circuit of FIG. 2 in accordance with illustrative embodiments of the invention.

### DESCRIPTION OF ILLUSTRATIVE EMBODIMENTS

In illustrative embodiments of the invention, an electric DC motor is configured to dynamically vary its current draw as a function of its input voltage and rated power. For example, if the input voltage increases, then embodiments of the invention decrease the current draw to maintain a substantially constant power. Conversely, if the input voltage decreases, then embodiments of the invention increase the current draw for the same purposes. The actual power of the motor thus should remain substantially at the rated power, consequently permitting maximum torque and speed. Details of illustrative embodiments are discussed below.

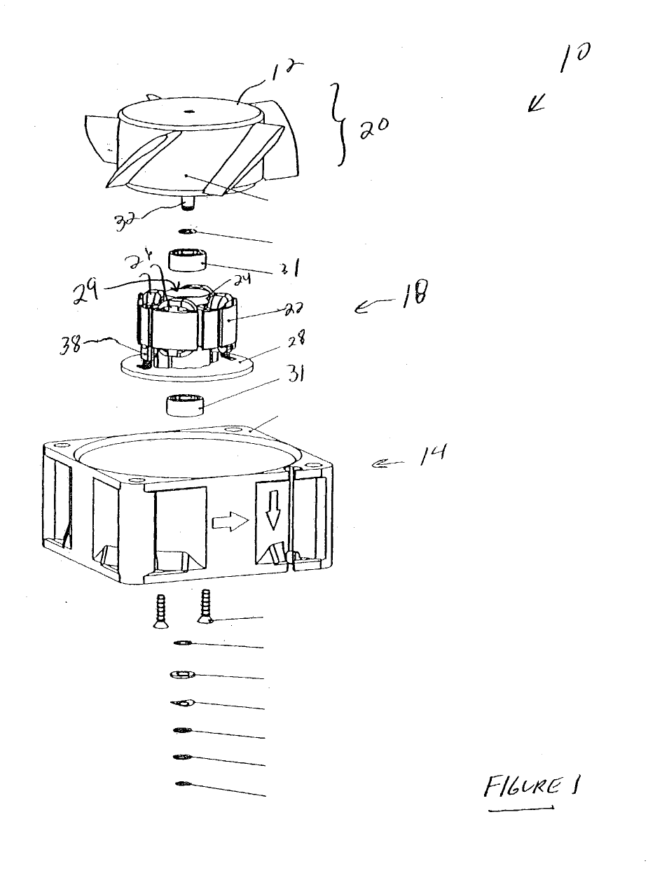

FIG. 1 schematically shows a motor that may implement illustrative embodiments of the invention. In particular, the motor 10 includes a propeller 12 and thus, is a part of a cooling fan. To that end, the motor 10 includes a housing 14 with venturi (not shown), a stator portion 18 secured to the housing 14, and a rotor 20, which includes the propeller 12. It should be noted that although the motor 10 is implemented as a fan, illustrative embodiments apply to other motor applications. Accordingly, description of the motor 10 as a fan is by illustration only and not intended to limit various embodiments of the invention.

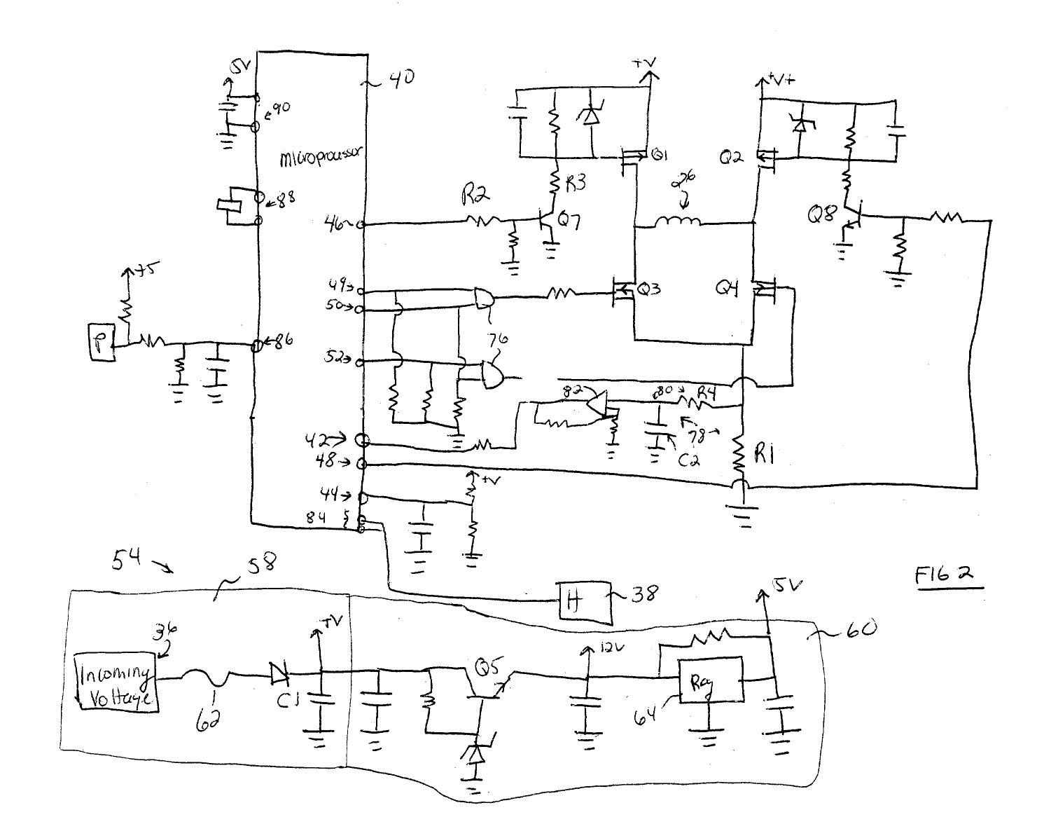

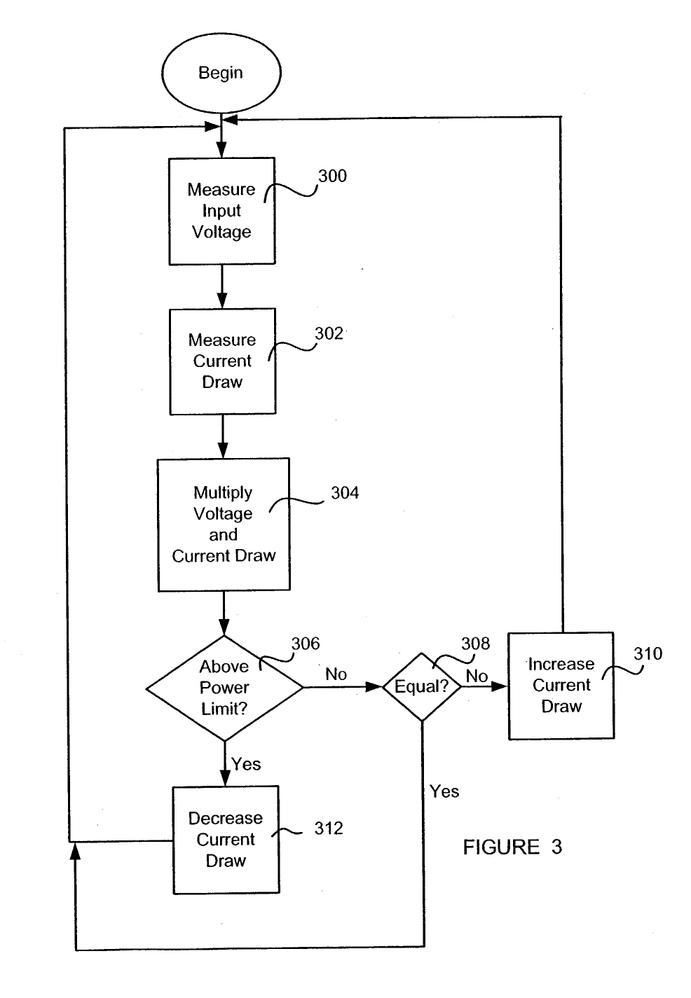

The stator 18 includes a stator core 22, a molded insulation layer 24 on the stator core 22 (e.g., see co-pending U.S. patent application No. 10/078,648, the disclosure of which is incorporated herein by reference), a coil 26 wrapped about the stator core and the insulation layer 24, and a circuit board 28 having electronics for controlling the energization of the coil 26 (discussed in greater detail below with reference to FIGS. 2 and 3). The insulation layer 24 includes an arbor 29 extending through a central tubular opening of the stator core 22. Bearings 31 are secured within the arbor 29 for receiving a rotor shaft (discussed below).

The rotor 20 includes a steel cup (not shown) for supporting the propeller 12, an annular permanent magnet circumscribing the interior of the steel cup, and a shaft 32 extending from the center of the steel cup. When assembled, the shaft 32 is received by the bearings 31 secured within the arbor 29.

FIG. 2 schematically shows a stator commutation circuit (“stator circuit 34”) implementing illustrative embodiments of the invention. The stator circuit 34, which is located on the circuit board 28, includes a plurality of circuit elements that effectuate the underlying commutation function in the manner summarized above. Namely, the stator circuit 34 varies current draw to maintain motor power at a substantially constant level, consequently optimizing motor performance.

To these ends, the stator circuit 34 includes an input 36 for receiving an input voltage that energizes the entire circuit, and a Hall Effect sensor 38 to detect the magnetic field produced by the rotating rotor 20. In addition, the stator circuit 34 also includes the above noted coil 26, which is selectively energized by four switches. In illustrative embodiments, the switches are metal oxide semiconductor field effect transistors (MOSFETS) and identified in FIG. 2 as first switch Q1, second switch Q2, third switch Q3, and fourth switch Q4.

In accordance with illustrative embodiments, the stator circuit 34 also includes a microprocessor 40 for controlling the switches Q1-Q4 in a manner that controls the current drawn by the coil 26. The microprocessor 40 illustratively may be a model number PIC16C712 processor, distributed by Microchip Technology Inc. of Chandler, Ariz. In the embodiment shown in FIGS. 2 and 3, the microprocessor 40 sets an effective voltage across the coil 26 in accordance with conventional pulse width modulation techniques. In alternative embodiments, the effective voltage across the coil 26 can be set in other known manners. Moreover, as known by those skilled in the art, a set of software instructions control operation of the microprocessor 40 to implement illustrative embodiments of the invention. Details of executed microprocessor processes are discussed below with reference to FIG. 3.

The microprocessor 40 includes a current sense input 42 to monitor the current drawn by the coil 26, and a voltage sense input 44 to monitor the input voltage. The voltage and current sensed at these inputs 42 and 44 are used to calculate the actual power being consumed by the motor (discussed below). The microprocessor 40 also includes a plurality of outputs to controllably deliver open and close signals to each of the switches Q1-Q4. In particular, the microprocessor 40 includes a first high side port 46 to control the first switch Q1, and a second high side port 48 to control the second switch Q2. The microprocessor 40 also includes first and second low side ports 49 and 50 to control the third switch Q3, and a third low side port 52 that, with the second low side port 50, controls the fourth switch Q4. Details of the interaction of each of these circuit components (i.e., the microprocessor 40, the four switches Q1-Q4, the coil 26, the voltage sense input 44, and the current sense input 42) are discussed below.

Specifically, the lower left corner of FIG. 2 shows a voltage input circuit 54 for producing the voltage that energizes the stator circuit 34. To that end, the voltage input circuit 54 has that prior noted input 36 for receiving an incoming DC voltage from an external source (e.g., 48 volts DC), a first stage 58 to produce the DC voltage identified as +V (i.e., powering, among other things, the first through fourth switches and the coil 26), and a second stage 60 to generate 5.0 volts for energizing the microprocessor 40 and other portions of the stator circuit 34.

The first stage 58 includes a fuse 62 to protect against current surges, a reverse polarity diode D1, and a capacitor C1. The voltage identified as +V is distributed about the stator circuit 34 by connecting to all locations in FIG. 2 having that same symbol. As discussed below, the voltage +V is the voltage used to determine motor power. Its value is a function of the prior noted incoming voltage, which can fluctuate.

The second stage 60 includes conventional regulation components, such as a coarse voltage regulation component (i.e., the transistor Q5 and Zener diode D2) and a regulator application specific integrated circuit 64. In a manner similar to the +V voltage, the node having the +5 V symbol is connected to all locations in FIG. 2 having that +5 V symbol.

As noted above, the microprocessor 40 controls the first through fourth switches Q1-Q4 to selectively energize the coil 26. To these ends, the switches Q1-Q4 are configured in an H-bridge configuration. The first and second switches Q1 and Q2 are considered to be “high side switches,” while the third and fourth switches Q3 and Q4 are considered to be “low side switches.” In a manner consistent with other H-bridge configurations, during each on/off cycle, one high side switch is on while one low side switch is on. The other two switches are off. To provide a current path and voltage, the two switches that are on are located diagonally across the coil 26.

In illustrative embodiments, the first and second switches Q1 and Q2 are P-channel MOSFETS, while the third and fourth switches Q3 and Q4 are N-channel MOSFETS. Accordingly, the source nodes of the first and second switches Q1 and Q2 are connected to the +V terminal of the voltage input circuit 54, while the source nodes of the third and fourth switches Q3 and Q4 are connected together. In addition, the drain nodes of the first and third switches Q1 and Q3 are connected, while the drain nodes of the second and fourth switches Q2 and Q4 are connected. The connected sources of the third and fourth switches Q3 and Q4 are coupled to ground via a current sense resistor R1 (discussed below).

The microprocessor 40 controls the frequency and duty cycles of the four switches Q1-Q4 by means of the above noted five high side and low side ports 46, 48, 49, 50, and 52. The first high side port 46 controls the first switch Q1 by selectively providing a turn-on signal to a first level shift transistor Q7. Specifically, the emitter node of the first level shift transistor Q7 is coupled to ground, while its base node is coupled to the first high side port 46(via a resistor R2). In addition, the collector node of the first level shift transistor Q7 is coupled to the gate of the first switch Q1 (also via a resistor R3). Consequently, application of a turn on voltage to the resistor R2 produces a current that turns on the first level shift transistor Q7. When on, the transistor Q7 effectively connects the gate node of the first switch Q1 to a voltage that is below that of the first switch source node. In other words, the gate node voltage of the first switch Q1 is less than its source node voltage. Because it is a P-channel MOSFET, this voltage relationship causes the first switch Q1 to turn on.

The second switch Q2 operates in a similar manner to that discussed with regard to the first switch Q1. Accordingly, the second switch Q2 also has an associated second level shift transistor Q8 and is selectively energized by the second high side port 48 on the microprocessor 40.

The first, second, and third low side ports 49, 50, and 52 of the microprocessor 40 respectively control the third and fourth switches Q3 and Q4. The first and third low side ports 49 and 52 control which one of the third or fourth switches Q3 and Q4 is to be on during a given time in the commutation cycle, while the second low side port 50 pulse width modulates the switch that is on (based upon the signals delivered by the first and third low side ports 49 and 52) in a manner that controls current draw as a function of power. Specifically, the gate node of the third switch Q3 is coupled with a conventional AND gate 76 that receives its input voltages from the first low side port 49 and the second low side port 50. In addition, as noted above, the source node of the third switch Q3 (and fourth switch Q4) is coupled to ground via the current sense resistor R1. Accordingly, because it is an N-channel MOSFET, application of a positive voltage to its gate (by its attached AND gates 76) causes the third switch Q3 to begin conducting current (i.e., causing it to turn on).

When the third switch Q3 is to be on, the AND gate 76 input from the first low side port 49 is high (i.e., logic level “one”) while the AND gate 76 input from the second low side port 50 is pulse width modulated to control current flow through the coil 26. This causes the gate node of the third switch Q3 to receive a pulse width modulated voltage. As a result, the third switch Q3 turns on and off in a manner that is controlled by the frequency and duty cycle specified by the second low side port 50. While the third switch Q3 is being modulated, the fourth switch Q4 is off.

The fourth switch Q4 operates in a substantially identical manner to that of the third switch Q3. Accordingly, the fourth switch Q4 also has a corresponding AND gate 76 that receives input from the second low side port 50 and the third low side port 52.

When the third switch Q3 is modulated to be on, current flows from the +V node of the regulator, through the second switch Q2, through the coil 26, and then through the third switch Q3. The current continues to flow through the current sense resistor R1 to ground. Conversely, when the third switch Q3 is modulated off (i.e., by pulse width modulation signals from the second low side port 50), current flow through the coil 26 is interrupted. Accordingly, current flow generated by the second switch Q2 is transmitted back to its source via a recirculating diode (not shown). Note that the fourth switch Q4 operates in a corresponding manner in concert with the first switch Q1.

As noted above, the current flowing through either of the low side switches Q3 or Q4 necessarily flows through the current sense resistor R1. This current flow generates a relatively low voltage, which is amplified and then fed to the current sense input 42 of the microprocessor 40. To that end, the stator circuit 34 has a current sense circuit 78 that includes both the noted current sense resistor R1 and a smoothing circuit 80 (comprising a resistor R4 and a capacitor C2) for generating a filtered average voltage of the voltage through the current sense resistor R1. This filtered average voltage is forwarded to an operational amplifier 82, which amplifies the filtered average voltage to produce an amplified voltage. The amplified voltage then is forwarded to the current sense input 42 of the microprocessor 40. The microprocessor 40 includes an internal analog to digital converter that converts the amplified voltage to a digital value for processing as discussed herein. This digital value represents the current through the coil 26.

As noted above and shown in FIG. 2, the microprocessor 40 includes a plurality of other ports. Among those is the above noted voltage sense input 44, which detects the input voltage +V, a pair of Hall sense ports 84 to detect output from the Hall sensor 38, an external PWM input 86 to permit external control of the motor 10 with some external PWM means, and an external clock port 88. In addition, the microprocessor 40 also includes ports to receive 5.0 volts from the voltage input circuit 54, and a ground port 90.

As noted above, the microprocessor 40 modulates the two low side switches Q3 and Q4 to control the effective voltage across the coil 26. In so doing, the microprocessor 40 effectively controls the current draw/flow through the coil 26. Accordingly, consistent with goals of various embodiments, if the input voltage (e.g., +V, which is a function of the incoming voltage to the regulator) increases, then the microprocessor 40 provides modulation pulses to the relevant low side switch(es) Q3 or Q4 at appropriate times to decrease current flow through the coil 26. In a corresponding manner, if the input voltage decreases, the microprocessor 40 provides the appropriate modulation pulses to the relevant low side switch(es) Q3 or Q4 to increase current flow through the coil 26. These modulation pulses are selected with an appropriate frequency and duty cycle to maintain motor operation substantially at the rated operating power.

FIG. 3 shows an illustrative process (executed by the microprocessor 40) for controlling the current draw of the coil 26 based upon the rated power and thus, the input voltage. As noted above, in the embodiments shown in FIGS. 1-3, the process is implemented as a series of computer instructions in any conventional programming language. Among other benefits, use of the microprocessor 40 and accompanying software code simplifies the design and modification of various system parameters (e.g., rated power of the motor 10).

The process begins at 300, in which the microprocessor 40 measures the input voltage +V via its voltage sense input 44. As noted above, the input voltage +V is a function of the incoming voltage. Accordingly, in the embodiment shown in FIG. 2, the input voltage +V effectively is the incoming voltage received at the voltage input circuit 54. Its magnitude may be lower by about a diode voltage drop, but its other characteristics are substantially the same as the incoming voltage.

Either simultaneously, before, or after the input voltage is measured, the current draw is measured (step 302). Accordingly, the current through the current sense resistor R1 is measured at the current sense input 42. To that end, the microprocessor 40 may access a look up table to convert the voltage received by the current sense port to a current value. This current value is used in later steps of the process to calculate power. It should be noted that the order that these measurements are made should not have a significant effect on the overall results of the process.

The microprocessor 40 then calculates the power by multiplying the incoming voltage value with the current draw value (step 304). This calculated power, which represents the actual power consumed by the motor 10, subsequently is compared against the rated power to determine if the current draw should be modified (step 306).

If the calculated power is equal to the rated power, then the current draw is not modified (step 308). In such case, the process returns to step 300. If the calculated power is less than the rated power, however, then the process continues to step 310, in which the microprocessor 40 causes the coil 26 to increase the current draw. To that end, the microprocessor 40 increases the duty cycle of the pulses modulated to the relevant low side switch Q3 and/or Q4. In other words, the microprocessor 40 modulates the relevant low side switch Q3 or Q4 in a manner that increases current flow through the coil 26. This increased current flow consequently increases motor torque and speed. The process then loops back to step 300, thus repeating the process.

Conversely, at step 306, if the calculated power is greater than the power limit, then the process continues to step 312, in which microprocessor 40 causes the coil 26 to decrease the current draw. To that end, the microprocessor 40 decreases the duty cycle of its pulse width modulated pulses via low side port 50. In other words, the microprocessor 40 modulates the relevant low side switch Q3 or Q4 in a manner that decreases current flow through the coil 26.

In illustrative embodiments, the duty cycle is increased (step 310) or decreased (step 312) by a preselected amount that is preprogrammed into the microprocessor 40. Accordingly, a change in the input voltage should produce a commensurate number of iterations of the process shown in FIG. 2 to cause the current draw to reach a desired value. As a result, the actual power of the motor 10 should be maintained at a substantially constant level (i.e., substantially at the rated power).

By way of example, if a given motor is rated to operate at 75 watts and the input voltage is 50 volts, then the microprocessor 40 dynamically selects the current draw to be 1.5 amperes. If the input voltage of such motor increases to 60 volts, then the microprocessor 40 lowers the current draw to 1.25 amperes, thus maintaining the rated 75 watt power. Maintaining the current in this manner maximizes torque and speed without exceeding the rated power.

In some embodiments, the rated power also is dynamically set at run time. For example, the microprocessor 40 may monitor the temperature of the coil 26, and then calculate a rated power based on such measured temperature. The microprocessor 40 thus may use this dynamically calculated rated power to calculate the current draw.

Instead of being a single power value, the rated power being compared against in step 306 may be a range of values around a specified rated power. For example, the range may be within five percent of the rated power. Accordingly, if the calculated power is within the range, then the current draw is not changed.

In illustrative embodiments, the motor 10 is implemented as a cooling fan used to cool telecommunications equipment. Accordingly, the motor 10 is configured to nominally receive a 48 volt input voltage. Of course, illustrative embodiments can be used across a range of applications and technologies. Discussion of the motor 10 as a fan used in a telecommunications applications thus is exemplary and not intended to limit the scope of the invention.

It also should be noted that a motor with an H-bridge configuration was discussed for exemplary purposes only. Accordingly, other types of motors may be used with illustrative embodiment of the invention. For example, three phase and bifilar type motor arrangements also may be used. Discussion of an H-bridge type motor thus is not intended to limit the scope of all embodiments of the invention.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and method may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made that will achieve some of the advantages of the invention without departing from the true scope of the invention.

What is claimed is:

1. A motor having a current draw, the motor comprising:
an input for receiving an input voltage; and
a current controller operatively coupled with the input, the current controller being capable of detecting the current draw by the motor,
the current controller being capable of changing the current draw as a function of the input voltage.

2. The motor as defined by claim 1 wherein the motor has a rated power value, the current controller being capable of controlling the current draw as a function of the rated power.

3. The motor as defined by claim 1 wherein the current controller is capable of changing the current draw inversely proportional to the input voltage.

4. The motor as defined by claim 1 wherein the current controller includes a pulse width modulator to control current draw.

5. The motor as defined by claim 1 wherein the current controller includes a programmable element capable of executing program code.

6. The motor as defined by claim 1 further including a stator and a rotor that is rotatably attached to the stator, the rotor speed being controlled by the current controller.

7. The motor as defined by claim 1 further including a coil, the current draw being a function of at least one characteristic of the coil.

8. The motor as defined by claim 1 further including a voltage sensor that is capable of measuring the input voltage, the voltage sensor being in electrical communication with the current controller.

9. A motor having a current draw, the motor comprising:
means for receiving an input voltage; and
means for controlling the current draw as a function of the input voltage.

10. The motor as defined by claim 9 wherein the motor has a rated power value, the controlling means including means for controlling the current draw based upon the rated power.

11. The motor as defined by claim 9 wherein the current controller includes means for changing the current draw inversely proportional to the input voltage.

12. The motor as defined by claim 9 wherein the controlling means includes a programmable element capable of executing program code.

13. The motor as defined by claim 9 further including a stator and a rotor that is rotatably attached to the stator, the rotor speed being controlled by the controlling means.

14. A method of controlling the speed of a motor, the method comprising:
receiving an input voltage that powers the motor;
calculating the power produced by the input voltage;
comparing the power produced by the input voltage to a given power; and
controlling current drawn by the motor as a function of the comparison of the power produced to the given power, the power produced by the input voltage being a function of the current drawn by the motor.

15. The method as defined by claim 14 wherein the current drawn is increased if the power produced is less than the given power.

16. The method as defined by claim 14 wherein the current drawn is decreased if the power produced is greater than the given power.

17. The method as defined by claim 14 wherein controlling the current draw includes pulse width modulating the input voltage.

18. The method as defined by claim 14 wherein the given voltage is preprogrammed into a programmable element that controls the current drawn, the programmable element capable of executing program code.

19. The method as defined by claim 14 further including calculating the value of the input voltage.

20. A computer program product for use on a computer system for controlling the speed of a motor, the computer program product comprising a computer usable medium having computer readable program code thereon, the computer readable program code comprising:
program code for receiving an input voltage that powers the motor;
program code for calculating the power produced by the input voltage;
program code for comparing the power produced by the input voltage to a given power; and
program code for controlling the current drawn by the motor as a function of the comparison of the power produced to the given power, the power produced by the input voltage being a function of the current drawn by the motor.

21. The computer program product as defined by claim 20 wherein the program code for controlling current includes program code for increasing the current drawn if the power produced is less than the given power.

22. The computer program product as defined by claim 20 wherein the program code for controlling current includes program code for decreasing the current drawn if the power produced is greater than the given power.

23. The computer program product as defined by claim 20 wherein the program code for controlling includes program code for pulse width modulating the input voltage.

24. The computer program product as defined by claim 20 further including program code for calculating the value of the input voltage.
